(19) United States
(12) Patent Application Publication
(10) Pub. No.: US 2020/0307229 A1
(43) Pub. Date: Oct. 1, 2020

(54) LIQUID STORAGE CONTAINER AND LIQUID EJECTION SYSTEM

(71) Applicant: SEIKO EPSON CORPORATION, Tokyo (JP)

(72) Inventors: Masahiro KARASAWA, Matsumoto-shi (JP); Kazuyuki HIRATA, Matsumoto-shi (JP); Yuji AOKI, Hara-mura (JP)

(73) Assignee: SEIKO EPSON CORPORATION, Tokyo (JP)

(21) Appl. No.: 16/829,505

(22) Filed: Mar. 25, 2020

(30) Foreign Application Priority Data
Mar. 26, 2019 (JP) 2019-057649

(51) Int. Cl. B41J 2/175

(52) U.S. Cl. CPC B41J 2/17513

(57) ABSTRACT

A liquid storage container that is equipped in a liquid ejection apparatus and supplies liquid to the liquid ejection apparatus is provided. The liquid storage container includes: a liquid storage box forming an outer shell of the liquid storage container; and a liquid storage bag accommodated in the liquid storage box, the liquid storage bag having a flexibility for storing liquid therein, wherein regardless of a posture of the liquid storage box, a first inner circumferential length of the liquid storage bag in one cross-section is larger than a second inner circumferential length of the liquid storage box in the one cross-section.

The present application is based on, and claims priority from JP Application Serial Number 2019-057649, filed Mar. 26, 2019, the disclosure of which is hereby incorporated by reference herein in its entirety.

### BACKGROUND

### 1. Technical Field

The present disclosure relates to a liquid storage container and a liquid ejection system.

### 2. Related Art

Cartridges equipped in a printing apparatus have been known to typically include a case detachably equipped to the printing apparatus, and a flexible liquid container accommodated in the case. JP-A-2016-37017 is an example of related art. Such cartridges are used as liquid storage containers that store liquid such as ink. For these cartridges, the dimensions of the liquid container is determined in consideration of impact resistance. Specifically, the length of the liquid container in a direction extending from the front end to the rear end of a liquid storage space in which liquid is stored is longer than the length of the space accommodating the case. The front end of the storage container is a region in which a liquid supply unit that supplies liquid to the printing apparatus is provided. The rear end of the storage container is an end opposite to the front end.

In the related art, loads to the liquid container other than impact is not sufficiently considered. The loads to the liquid container other than impact refer to, for example, a water head pressure that is applied to a lower part of the liquid container due to the liquid stored. Further, in the related art, sufficient consideration has not been given to the case where the direction of a load applied to the liquid container changes to a direction other than that directing from the front end to the rear end of the liquid storage space due to the cartridge changing the posture.

### SUMMARY

According to an aspect of the present disclosure, a liquid storage container that is equipped in a liquid ejection apparatus and supplies liquid to the liquid ejection apparatus is provided. The liquid storage container includes: a liquid storage box forming an outer shell of the liquid storage container; and a liquid storage bag accommodated in the liquid storage box, the liquid storage bag having a flexibility for storing liquid therein, wherein regardless of a posture of the liquid storage box, a first inner circumferential length of the liquid storage bag in one cross-section is larger than a second inner circumferential length of the liquid storage box in the one cross-section.

### BRIEF DESCRIPTION OF THE DRAWINGS

FIG. 1 is a schematic view illustrating a liquid ejection system according to a first embodiment.

FIG. 2 is a perspective view of a liquid storage container.

FIG. 3 is a perspective view of a liquid storage body.

FIG. 4 is a view illustrating an appearance of the liquid storage container when it is not equipped in a liquid ejection apparatus.

FIG. 5 is a table illustrating how the liquid storage container is in a non-mounted state.

FIG. 6 is a partial cross-sectional view of a cross-section taken along the line VI-VI in FIG. 5.

FIG. 7 is a schematic cross-sectional view of the liquid storage container in a comparative example.

FIG. 8 is a table illustrating how the liquid storage container is in a non-equipped state.

### DESCRIPTION OF EXEMPLARY EMBODIMENTS

### A. First Embodiment

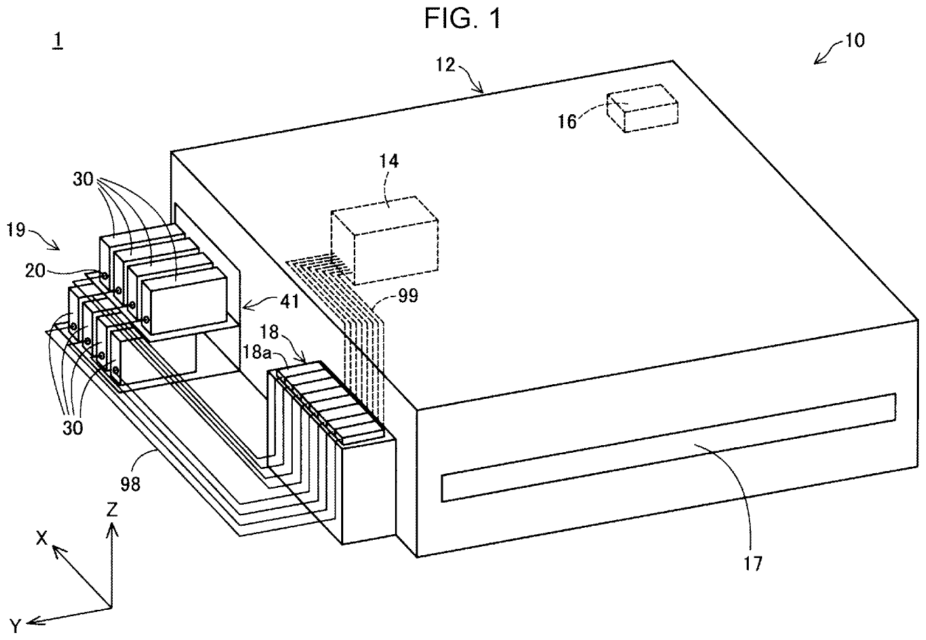

FIG. 1 is a schematic view illustrating a liquid ejection system 1 according to a first embodiment. FIG. 1 shows the X, Y, and Z axes, which are three spatial axes that are orthogonal to one another. The direction extending along the X axis is referred to as an X direction, the direction extending along the Y axis is referred to as a Y direction, and the direction extending along the Z axis is referred to as a Z direction. The Z direction is the vertical direction. The −Z direction is a vertically downward direction, and the +Z direction is a vertically upward direction. In FIG. 1, the liquid ejection system 1 is placed on an XY plane, which is a plane parallel to the X axis and the Y axis. The XY plane is a horizontal plane perpendicular to the Z direction.

The liquid ejection system 1 includes a liquid ejection apparatus 10, a liquid storage container 30, a main shelf 19, and a sub shelf 18. The liquid ejection apparatus 10 is an inkjet textile printer that performs printing by ejecting ink as liquid onto a medium such as a cloth product. Further, the liquid ejection apparatus 10 may also be a printer that performs printing by ejecting ink onto a paper sheet.

Eight liquid storage containers 30 are provided. The eight liquid storage containers 30 each store liquid of different colors. The eight liquid storage containers 30 store liquid of various colors including, for example, cyan, magenta, yellow, black, orange, and gray.

The main shelf 19 is disposed outside the liquid ejection apparatus 10, and holds eight liquid storage containers 30. The main shelf 19 has a two-stage configuration, and an upper shelf and a lower shelf each hold four liquid storage containers 30.

The sub shelf 18 holds eight sub tanks 18a. The eight sub tanks 18a correspond to the eight liquid storage containers 30, respectively. The liquid storage container 30 communicates with the corresponding sub tank 18a via a flexible first tube 98.

One end of the first tube 98 is disposed on the main shelf 19, and the other end is disposed on the sub shelf 18. Eight first tubes 98 are provided corresponding to the respective liquid storage containers 30. Liquid stored in the liquid storage container 30 is supplied to the corresponding sub tank 18a via the first tube 98 by a suction mechanism, which is not shown, of the liquid ejection system 1.

The liquid ejection apparatus 10 includes an outer shell 12, a liquid ejection unit 14, a control unit 16, a first tube 98, a mounting unit 20, and a second tube 99. The outer shell 12 has a substantially cuboid outer shape. The outer shell 12 forms an outer surface of the liquid ejection apparatus 10.

The liquid ejection unit 14 is provided inside the outer shell 12. The liquid ejection unit 14 communicates with the sub tank 18a via a flexible second tube 99 provided for each sub tank 18a. Liquid that has passed through the second tube 99 is supplied to the liquid ejection unit 14. In the present embodiment, liquid in the sub tank 18a is supplied to the liquid ejection unit 14 via the second tube 99 by a pressure applying mechanism, which is not shown, of the liquid ejection apparatus 10. The liquid ejection unit 14 reciprocates in the Y direction by a drive mechanism, which is not shown. The liquid ejection unit 14 reciprocated in the Y direction while ejecting liquid, and moves in the X direction inside the outer shell 12 by a transport mechanism, which is not shown. Thus, liquid is ejected onto a medium. The medium onto which liquid has been ejected is outputted to the outside of the outer shell 12 through an output port 17 provided on the surface of the outer shell 12 on the −X side. The liquid ejection unit 14 may also be a line head, which is fixed in position without reciprocating in the Y direction.

The control unit 16 is disposed inside the outer shell 12. The control unit 16 controls operations of the liquid ejection apparatus 10. For example, the control unit 16 controls operations of the aforementioned drive mechanism and the transport mechanism. Further, the control unit 16 is electrically coupled to the liquid storage container 30 to transmit and receive various information to and from the liquid storage container 30. Examples of the various information include color information of the liquid storage container 30, and information indicative of whether or not the liquid storage container 30 is equipped in the liquid ejection apparatus 10.

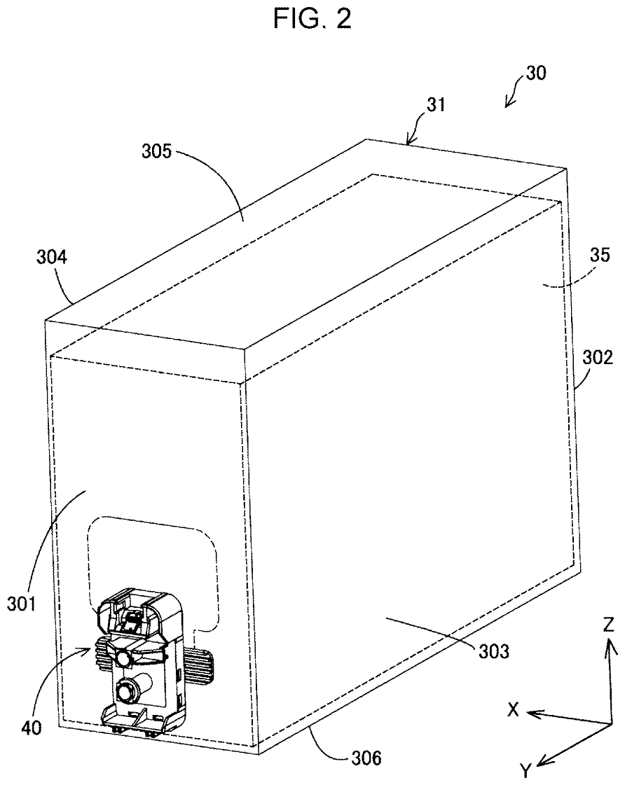

FIG. 2 is a perspective view of the liquid storage container 30. FIG. 2 illustrates the liquid storage container 30 in a equipped posture, which is a posture when equipped in the liquid ejection system 1 shown in FIG. 1. As shown in FIG. 2, the liquid storage container 30 includes a liquid storage box 31 and a liquid storage body 35.

The liquid storage box 31 forms an outer shell of the liquid storage container 30, and removably accommodates the liquid storage body 35. The liquid storage box 31 has a substantially cuboid outer shape. Further, the liquid storage box 31 defines a cuboid internal space as an accommodating space for accommodating the liquid storage body 35. The liquid storage box 31 may be made of various materials such as paper and resin. In the present embodiment, the liquid storage box 31 is made of a cardboard. Accordingly, the manufacturing cost of the liquid storage container 30 can be reduced.

The liquid storage box 31 has a first surface 301, a second surface 302, a third surface 303, a fourth surface 304, a fifth surface 305, and a sixth surface 306. In the following description, the surfaces 301 to 306 in a equipped state will be described. The first surface 301 is a front surface of the liquid storage container 30, which is the outer wall extending in the XZ plane and located on the +Y side. A connector 40 is provided on the first surface 301. The second surface 302 is a rear surface of the liquid storage container 30, which is the outer wall extending in the XZ plane and located on a side opposite to the first surface 301. The third surface 303 and the fourth surface 304 are side surfaces of the liquid storage container 30. The third surface 303 is the outer wall extending in the YZ plane and located on the −X side. The fourth surface 304 is the outer wall extending in the YZ plane and located on a side opposite to the third surface 303. The fifth surface 305 is a top surface of the liquid storage container 30, which is the outer wall extending in the XY plane and located on the +Z side. The sixth surface 306 is a bottom surface of the liquid storage container 30, which is the outer wall extending in the XY plane and located on a side opposite to the top surface 305. The sixth surface 306 faces the main shelf 19 shown in FIG. 1 when it is in the equipped state.

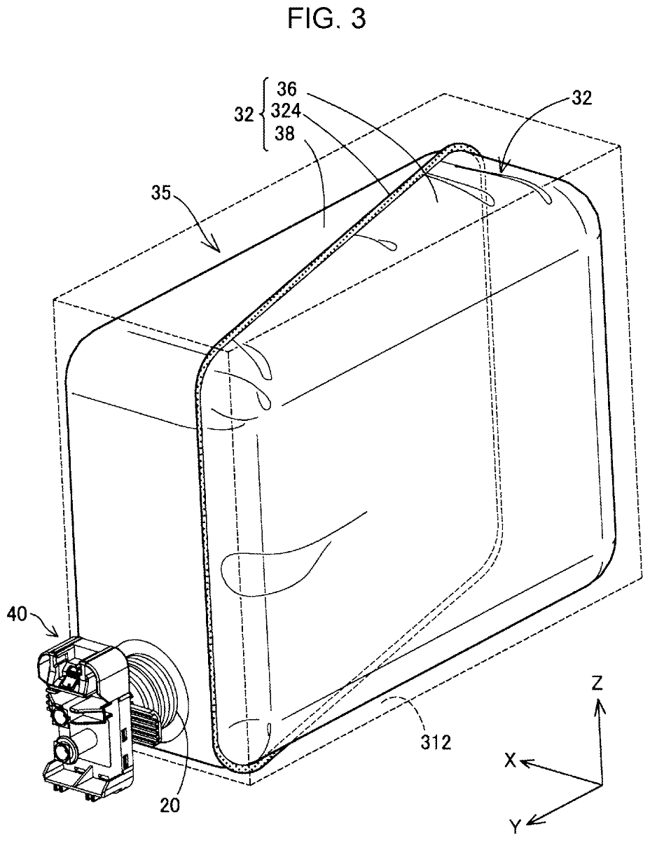

FIG. 3 is a perspective view of a liquid storage body 35. The liquid storage body 35 is a bag-shaped member defining an internal space for storing liquid. The liquid storage body 35 includes a liquid storage bag 32, a connector 40 to which the first tube 98 of FIG. 1 is coupled, and a mounting unit 20 that allows the liquid storage bag 32 and the connector 40 to communicate with each other. The liquid storage bag 32 is a bag-shaped member, and filled with liquid. The liquid in the liquid storage bag 32 is supplied from the liquid storage bag 32 to the liquid ejection apparatus 10 via the mounting unit 20. As the liquid is consumed, the volume of the liquid storage bag 32 decreases. When the liquid storage bag 32 becomes empty or almost empty after the consumption of the liquid, the liquid storage body 35 is replaced with a new one. The liquid storage container 30 is in a horizontal posture when in use. The horizontal posture refers to a posture in which the dimension in the Z direction is smaller than at least one of the dimension in the X direction and the dimension in the Y direction. Further, in the present embodiment, the liquid stored in the liquid storage body 35 has a volume smaller than the volume of the liquid storage box 31. In the present embodiment, the volume of the liquid storage body 35 when fully filled with liquid is 3 liters. The volume of the liquid storage body 35 is merely an example. The volume of the liquid storage body 35 may be less than 3 liters or may be more than 3 liters.

The liquid storage bag 32 is a bag-shaped member made of a flexible film, and filled with liquid. Since the liquid storage bag 32 has flexibility, the liquid storage body 35 can flexibly deform according to an external force. Accordingly, the liquid storage body 35 can change the outer shape according to the accommodating space in the liquid storage box 31 while being accommodated in the liquid storage box 31. In the present embodiment, the liquid storage body 35 accommodated in the liquid storage box 31 deforms into a substantially cuboid shape in line with the accommodating space in the liquid storage box 31 indicated by the dotted line in FIG. 3.

The liquid storage bag 32 is a pillow type bag, which is formed by two rectangular film members 36 and 38. The liquid storage bag 32 has a welded portion 324 in which two film members 36 and 38 are welded. In the present embodiment, two film members 36 and 38 are welded at four sides. The welded portion 324 is formed on the outer periphery of the liquid storage bag 32, and is located on a bottom 312 of the accommodating space in the liquid storage box 31 in the equipped state shown in FIG. 3.

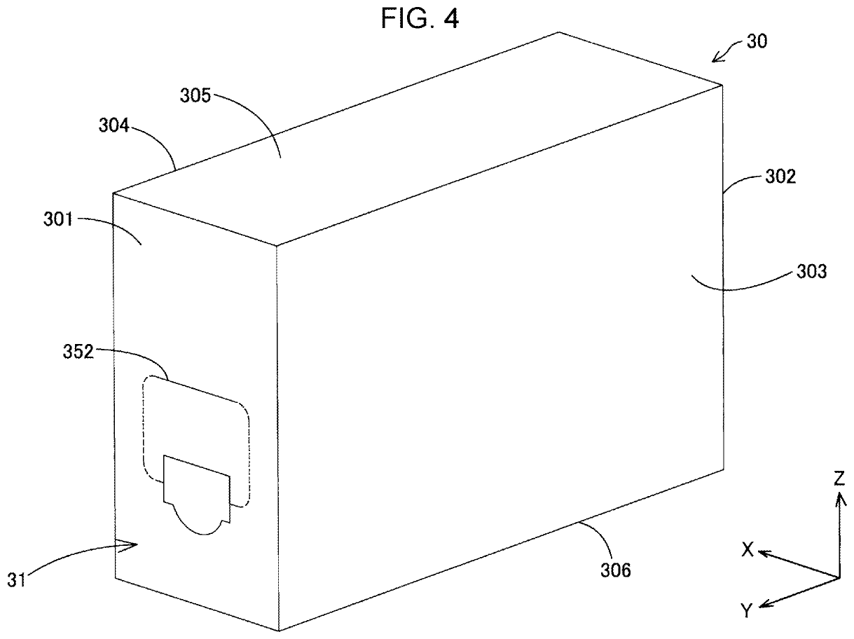

FIG. 4 is a view illustrating an appearance of the liquid storage container 30 in the non-equipped state in which it is not equipped in the liquid ejection apparatus 10. In the non-equipped state, the liquid storage container 30 accommodates the mounting unit 20 in the liquid storage box 31. The first surface 301 of the liquid storage box 31 includes a lid 352. The boundary between the lid 352 and the remaining portion of the first surface 301 is formed by a perforation, which facilitates separation. A user opens the lid 352 when mounting the liquid storage container 30 in the liquid ejection apparatus 10. Then, the user puts his/her hand into the liquid storage box 31, and pulls out the connector 40 from inside to expose the connector 40 to the outside of the liquid storage box 31. Since the volume of the liquid in the liquid storage body 35 is smaller than the volume of the liquid storage box 31, the liquid storage box 31 has a space for the liquid storage body 35 to deform. Accordingly, the liquid storage body 35 can deform to form a space near the lid 352. Thus, the user can easily pull out the connector 40.

The liquid storage container 30, when in the non-equipped state, for example, in a transport state or a storage state, can take a posture other than the equipped posture, in which the sixth surface 306 is taken as the bottom. When not equipped in the liquid ejection apparatus 10, the liquid storage container 30 may take a posture in which any of the first to fifth surfaces 301 to 305, rather than the sixth surface 306, is taken as the bottom. When the liquid storage container 30 takes a posture different from the equipped posture, the liquid storage bag 32, having flexibility, may deform in the liquid storage box 31 due to the gravitational force. Thus, the liquid storage bag 32 can deform according to the posture.

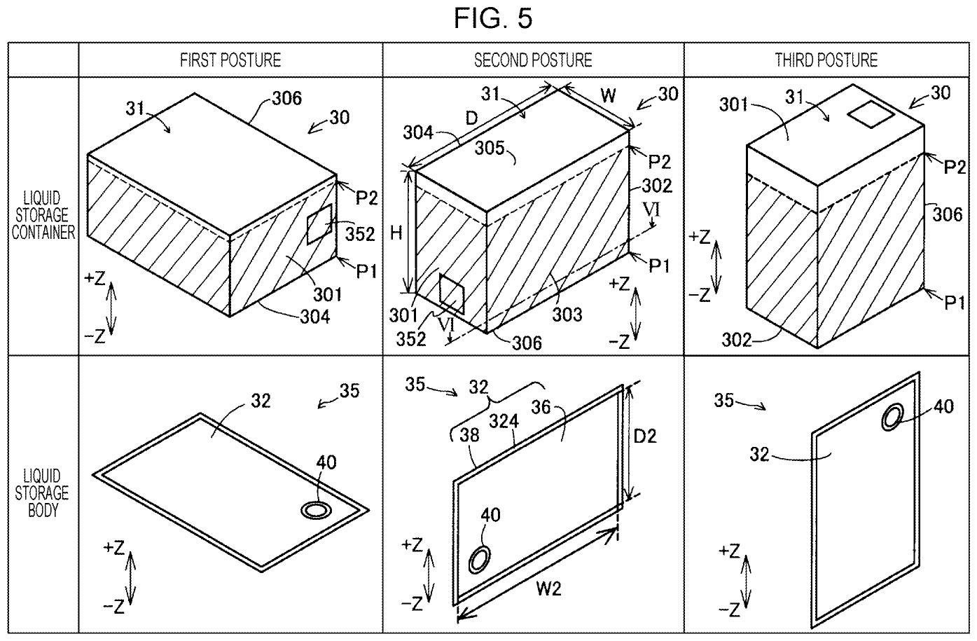

FIG. 5 is a table illustrating how the liquid storage container 30 is in the non-equipped state. FIG. 5 uses three postures as examples, which include a first posture in which the fourth surface 304 is taken as the bottom, a second posture in which the sixth surface 306 is taken as the bottom, and a third posture in which the second surface 302 is taken as the bottom. The upper row of the table in FIG. 5 shows schematic appearance of the liquid storage container 30 in each posture. Further, the lower row of the table in FIG. 5 schematically shows how the liquid storage body 35 is accommodated in the liquid storage container 30. In FIG. 5, the Z direction, which is the vertical direction, is indicated. In addition, although the liquid storage body 35 is illustrated in a two-dimensional manner in FIG. 5, the liquid storage body 35 is accommodated in the liquid storage box 31 after it is filled with liquid. Further, although the volume of the liquid storage body 35 shown in FIG. 5 is 3 liters, the volume is not limited thereto.

The liquid storage body 35 is accommodated in the liquid storage box 31 with the first film member 36, which is one of the two film members, provided with the connector 40 facing the third surface 303 of the liquid storage box 31. Further, the liquid storage body 35 is accommodated in the liquid storage box 31 such that the connector 40 is located at a position close to the first surface 301 and the sixth surface 306. In the present embodiment, the connector 40 is provided on the first film member 36 at a position close to the welded portion 324 at a corner between two sides. Since the liquid storage body 35 is thus accommodated in the liquid storage box 31, the connector 40 is prevented from being accommodated at a position farther from the lid 352.

The size of the internal space of the liquid storage box 31 will now be described. In the second posture, which corresponds to the equipped posture, the length in the Z direction is a height H. In the horizontal direction perpendicular to the Z direction, the length extending along the first surface 301 is a width W, and the length extending along the third surface 303 is a depth D. In the present embodiment, the depth D is larger than both the width W and the height H.

The size of the internal space of the liquid storage body 35 will now be described. The first film member 36 and the second film member 38 have the same dimensions. In the first film member 36 and the second film member 38, the length in a first direction extending along the welded portion 324 in the region defining the internal space is a first dimension D2. In the first film member 36 and the second film member 38, the length in a second direction extending along the welded portion 324 in the region defining the internal space is a second dimension W2. In the present embodiment, the first dimension D2 is smaller than the second dimension W2.

The first dimension D2 and the second dimension W2 satisfy all the three conditions shown in the following formulas (1) to (3):

First dimensionD2×2>WidthW×2+HeightH×2 (1)

Second dimensionW2×2>DepthD×2+WidthW×2 (2)

First dimensionD2×2+Second dimensionW2×2>HeightH×2+DepthD×2 (3)

The liquid storage bag 32, having low stretchability, has a constant inner circumferential length even when filled with liquid. The first dimension D2×2 is an inner circumferential length of the liquid storage bag 32 in one cross-section perpendicular to the Z axis in the third posture. Further, the width W×2+height H×2 is an inner circumferential length of the liquid storage box 31 in one cross-section perpendicular to the Z axis in the third posture. The second dimension W2×2 is an inner circumferential length of the liquid storage bag 32 in one cross-section perpendicular to the Z axis in the second posture. Further, the depth D×2+width W×2 is an inner circumferential length of the liquid storage box 31 in one cross-section perpendicular to the Z axis in the second posture. The first dimension D2×2+second dimension W2×2 is an inner circumferential length of the liquid storage bag 32 in one cross-section perpendicular to the Z axis in the first posture. Further, the height H×2+depth D×2 is an inner circumferential length of the liquid storage box 31 in one cross-section perpendicular to the Z axis in the first posture. In the conditions of the formulas (1) to (3), the left side is preferably larger than the right side by 10 mm or more, and more preferably by 30 mm or more. In the conditions of the formulas (1) to (3) of the present embodiment, the left side is larger than the right side by 30 mm or more.

When the formula (1) is satisfied, the inner circumferential length of the liquid storage body 35 is larger than the inner circumferential length of the liquid storage box 31 in the third posture. The inner circumferential length is a length in the horizontal direction in each posture on the inner surface defining the internal space. That is, the inner circumferential length is a length around the cross-section defining the internal space when an object is cut along one horizontal cross-section in each posture. When the formula (2) is satisfied, the inner circumferential length of the liquid storage body 35 is larger than the inner circumferential length of the liquid storage box 31 in the second posture. Further, when the formula (3) is satisfied, the inner circumferential length of the liquid storage body 35 is larger than the inner circumferential length of the liquid storage box 31 in the third posture.

As described above, in each posture, the inner circumferential length of the liquid storage body 35 is larger than the inner circumferential length of the liquid storage box 31. Specifically, in each posture, the inner circumferential length of the liquid storage body 35 is larger than the inner circumferential length of the liquid storage box 31 by 30 mm or more. Accordingly, the liquid storage body 35 is in contact with the inner wall of the liquid storage box 31 without a gap, extending from a first position P1, which is the lower end of the liquid storage body 35 in the Z direction, to a second position P2, which is a position on the +Z side of the first position P1. In the upper row of FIG. 5, a contact area between the liquid storage body 35 and the inner wall of the liquid storage box 31 is indicated by hatching. Further, in a region of the liquid storage body 35 on which the connector 40 is provided, the connector 40 may be sandwiched between the liquid storage bag 32 and the liquid storage box 31. Specifically, in a posture other than the third posture in which the connector 40 is located on the top surface, the connector 40 may be sandwiched between the liquid storage bag 32 and the liquid storage box 31. In this case as well, since the liquid storage bag 32 can deform according to the shape of the connector 40, the liquid storage body 35 can be in contact with the inner wall of the liquid storage box 31 without a gap.

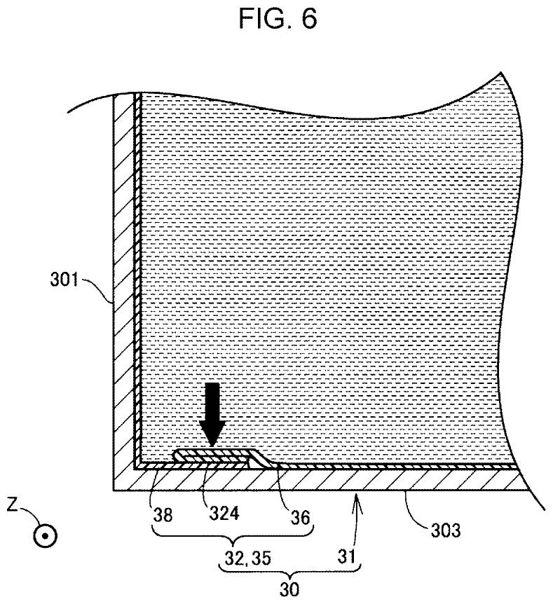

FIG. 6 is a partial cross-sectional view of a cross-section taken along the line VI-VI in FIG. 5. The liquid storage body 35 receives a force directed from the inside to the outside due to a water head pressure applied by the liquid stored therein. As described above, the liquid storage body 35 is accommodated while being in contact with the inner wall of the liquid storage box 31. For example, as shown in FIG. 6, the welded portion 324 is pressed against the liquid storage box 31. For this reason, the welded portion 324 is less likely to be damaged by the water head pressure. Accordingly, the risk of breakage of the liquid storage container 30 due to the water head pressure is reduced. Although FIG. 5 illustrates the liquid storage container 30 in the second posture as an example, the risk of breakage of the liquid storage container 30 due to the water head pressure can be reduced in any posture including the first posture and the third posture. Further, although the description is not given in connection with FIGS. 4 and 5, the risk of breakage of the liquid storage container 30 due to the water head pressure is also reduced, as with the case of the second posture, even in a posture in which the first surface 301, the third surface 303, or the fifth surface 305 is taken as a bottom.

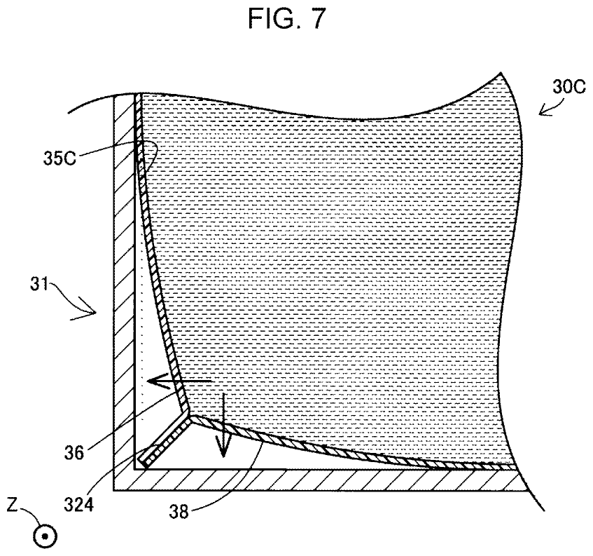

FIG. 7 is a schematic cross-sectional view of a liquid storage container 30C in a comparative example. The liquid storage container 30C of the comparative example differs from the liquid storage container 30 of the first embodiment in that the inner circumference of the liquid storage body 35C is smaller than that of the liquid storage box 31. As shown in FIG. 6, in the liquid storage container 30C of the comparative example, a gap is formed between the liquid storage body 35 and the inner wall of the liquid storage box 31. The gap is likely to be formed at a corner between two side surfaces. When a gap is formed between the liquid storage body 35C and the liquid storage box 31, a load due to the water head pressure in a range where the gap is formed is supported only by the liquid storage body 35C. In this case, when the welded portion 324 is located in the range where the gap is formed, a load is applied to the welded portion 324 in a direction that separate the first film member 36 and the second film member 38 from each other. Accordingly, in the comparative example, the risk of breakage of the liquid storage container 30 due to the water head pressure is larger than the first embodiment.

According to the first embodiment described above, the liquid storage body 35 and the wall of the liquid storage box 31 are in contact with each other at the lower end including the first position P1, which is the lower end in the Z direction, regardless of the posture of the liquid storage container 30 such as that during transport. Accordingly, when a lower part of the liquid storage body 35 is subjected to a water head pressure by the liquid accommodated therein, the liquid storage container 30 can reduce the risk of breakage of the liquid storage body 35 due to the water head pressure. Since the liquid storage container 30 can be stored and transported in any posture, the liquid storage container 30 can be easily handled. Further, the risk of breakage is also reduced even when the water head pressure increases due to an increase of the volume of the liquid storage container 30. Therefore, a change in design to increase the volume of the liquid storage container 30 is facilitated.

Further, according to the first embodiment described above, the liquid storage body 35 is in contact with the inner wall of the liquid storage box 31 without a gap, extending from the first position P1, which is the lower end, to a second position P2 in any posture. Accordingly, the liquid storage body 35 is restricted from moving in the liquid storage box 31 regardless of the posture. The liquid storage body 35 is less likely to be displaced in the liquid storage box 31 during transport and storage. Therefore, the position where the connector 40 is provided in the liquid storage container 30 is not limited to a specific position such as a position easy to fix, the degree of freedom in design of the liquid storage container 30 is increased. In addition, since there is no need of separate member for fixing the connector 40, the manufacturing cost of the liquid storage container 30 is reduced.

### B. Second Embodiment

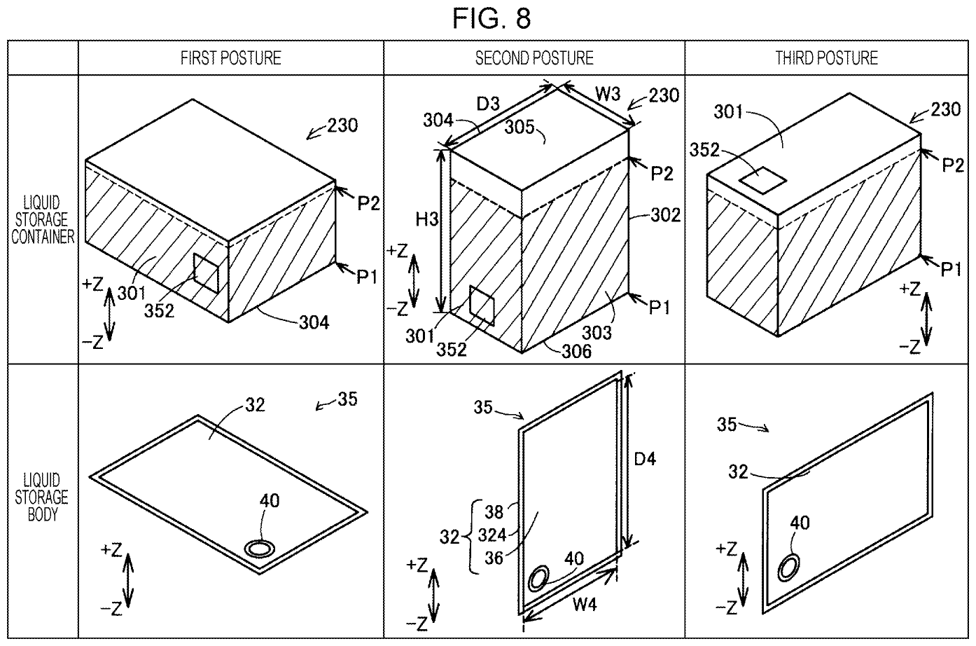

FIG. 8 is a table illustrating how the liquid storage container 230 is in the non-equipped state. The liquid storage container 230 of the second embodiment differs from the liquid storage container 30 of the first embodiment in the outer shape. Further, although the volume of the liquid storage bag 32 of the second embodiment is 10 liters, the volume is merely an example. That is, the volume may be larger than 10 liters, or smaller than 10 liters. In the following description, the same components as those of the first embodiment are denoted by the same reference numerals, and the detailed description thereof is omitted.

FIG. 8 uses three postures as examples, which include a first posture in which the fourth surface 304 is taken as the bottom, a second posture in which the sixth surface 306 is taken as the bottom, and a third posture in which the second surface 302 is taken as the bottom. The upper row of the table in FIG. 8 shows schematic appearance of the liquid storage container 230 in each posture. Further, the lower row of the table in FIG. 8 schematically shows how the liquid storage body 35 is accommodated in the liquid storage container 230. In FIG. 8, the Z direction, which is the vertical direction, is indicated. In addition, as with FIG. 5, the liquid storage body 35 in FIG. 8 is illustrated in a two-dimensional manner.

The liquid storage container 230 of the second embodiment is equipped in the liquid ejection apparatus 10 in a vertical posture, which is shown as the second posture. The vertical posture refers to a posture in which the dimension in the Z direction is larger than the dimension in the X direction and the dimension in the Y direction.

The size of the internal space of the liquid storage box 31 will now be described. In the second posture, which corresponds to the equipped posture, the length in the Z direction is a height H3. In the horizontal direction perpendicular to the Z direction, the length extending along the first surface 301 is a width W3, and the length extending along the third surface 303 is a depth D3. In the present embodiment, the height H3 is larger than both the width W3 and the depth D3.

The size of the internal space of the liquid storage body 35 will now be described. The first film member 36 and the second film member 38 have the same dimensions. In the first film member 36 and the second film member 38, the length in a first direction extending along the welded portion 324 in the region defining the internal space is a first dimension D4. In the first film member 36 and the second film member 38, the length in a second direction extending along the welded portion 324 in the region defining the internal space is a second dimension W4. In the present embodiment, the first dimension D4 is smaller than the second dimension W4.

The first dimension D2 and the second dimension W2 satisfy all the three conditions shown in the following formulas (4) to (6):

First dimensionD4×2>WidthW3×2+HeightH3×2 (4)

Second dimensionW4×2>DepthD3×2+WidthW3×2 (5)

First dimensionD4×2+Second dimensionW4×2>HeightH3×2+DepthD3×2 (6)

In the conditions of the formulas (4) to (6), the left side is preferably larger than the right side by 10 mm or more, and more preferably by 30 mm or more. In the conditions of the formulas (4) to (6) of the present embodiment, the left side is larger than the right side by 30 mm or more.

As described above, in each posture, the inner circumferential length of the liquid storage body 35 is larger than the inner circumferential length of the liquid storage box 31. Specifically, in each posture, the inner circumferential length of the liquid storage body 35 is larger than the inner circumferential length of the liquid storage box 31 by 30 mm or more. Accordingly, the liquid storage body 35 is in contact with the inner wall of the liquid storage box 31 without a gap, extending from a first position P1, which is the lower end of the liquid storage body 35 in the Z direction, to a second position P2, which is a position on the +Z side of the first position P1. In the upper row of FIG. 4, a contact area between the liquid storage body 35 and the inner wall of the liquid storage box 31 is indicated by hatching.

### C. Other Embodiments

### C1. First Other Embodiment

In the aforementioned embodiments, the liquid storage body 35 is a pillow-like bag. However, the embodiment is not limited thereto. For example, the liquid storage body 35 may also be a gusset type bag or a standing pouch bag. For example, a gusset type liquid storage body is made of four rectangular film members, which include two main films and two side films. The two main films face each other and form the main faces of the liquid storage body. The two side films face each other. The gusset type liquid storage body has a welded portion in which one of these four film members is welded to the other film members.

### C2. Second Other Embodiment

In the above embodiment, the liquid storage box 31 has a substantially cuboid shape. However, the embodiment is not limited thereto. For example, the liquid storage box 31 has a polygonal prism shape. Further, the internal space of the liquid storage box 31 may also have a shape other than a cuboid shape.

The above first and second other embodiments can also achieve the same effect as the aforementioned embodiments since they have the same configuration.

### C3. Third Other Embodiment

The present disclosure is not limited to ink jet printers, and ink tanks for supplying ink to ink jet printers, and can also be applied to liquid ejection apparatuses that eject various liquid including ink, and liquid tanks for storing the liquid. For example, the present disclosure can be applied to various liquid ejection apparatuses and their liquid tanks as follows.

1. Image recording apparatuses such as facsimile machines
2. Color material ejection apparatuses used for manufacturing color filters for image display apparatuses such as liquid crystal displays
3. Electrode material ejection apparatuses used for forming electrodes of organic EL (electro luminescence) displays, surface emitting displays (field emission displays, FEDs), and the like
4. Liquid ejection apparatuses for ejecting liquid including bioorganic substances used for manufacturing biochips
5. Sample ejection apparatuses as precision pipettes
6. Lubricant ejection apparatuses
7. Resin liquid ejection apparatuses
8. Liquid ejection apparatuses that eject lubricant in a pinpoint manner onto precision machines such as watches and cameras
9. Liquid ejection apparatuses that eject transparent resin liquid such as an ultraviolet curable resin liquid onto a substrate for forming micro hemisphere lenses (optical lenses) used for optical communication elements and the like
10. Liquid ejection apparatuses that eject acidic or alkaline etching solution for etching a substrate and the like
11. Liquid ejection apparatuses including a liquid ejection head that ejects any other small amount of liquid droplets

The “liquid droplets” refers to a state of liquid ejected from the liquid ejection apparatus, and includes granular shape, tear shape, and thread shape in a trailing shape. Further, the term “liquid” as used herein refers to any material that can be ejected by the liquid ejection apparatus. For example, “liquid” may be a material in a state of a liquid phase, and includes liquid state materials having high or low viscosity, and liquid state materials such as sol, gel water, other inorganic solvents, organic solvents, solutions, liquid resins, liquid metal (metal melt). The “liquid” further includes, in addition to liquid as one state of substances, materials in which particles of a functional material having solids such as pigments and metal particles are dissolved, dispersed, or mixed in a solvent. In addition, representative examples of the liquid include ink described in the above embodiment, liquid crystals and the like. Here, the ink is intended to include various types of liquid compositions such as general water-based ink, oil-based ink, gel ink and hot melt ink.

The present disclosure is not limited to the above embodiments and can be embodied in various configurations without departing from the spirit thereof. For example, technical features in the embodiments corresponding to the technical features in the respective embodiments described in the summary can be appropriately replaced or combined in order to solve part or all of the above problems or achieve part or all of the above effects. Further, technical features can be appropriately deleted as long as they are not described in the specification as indispensable features.

1. According to an aspect of the present disclosure, a liquid storage container that is equipped in a liquid ejection apparatus and supplies liquid to the liquid ejection apparatus is provided. The liquid storage container includes: a liquid storage box forming an outer shell of the liquid storage container; and a liquid storage bag accommodated in the liquid storage box, the liquid storage bag having a flexibility for storing liquid therein, wherein regardless of a posture of the liquid storage box, a first inner circumferential length of the liquid storage bag in one cross-section is larger than a second inner circumferential length of the liquid storage box in the one cross-section. According to the liquid storage container of this aspect, the liquid storage bag and a wall of the liquid storage box are in contact with each other at a lower end including a lower end in the vertical direction, regardless of the posture of the liquid storage box. Accordingly, when a lower part of the liquid storage bag is subjected to a water head pressure by the liquid accommodated therein, the liquid storage container can reduce the risk of breakage of the liquid storage bag due to the water head pressure.

2. In the liquid storage container of the above aspect, the first inner circumferential length may be longer than the second inner circumferential length by 10 mm or more. The liquid storage container of this aspect can reduce the risk of breakage of the liquid storage bag due to the water head pressure.

3. In the liquid storage container of the above aspect, the liquid storage bag is composed of two rectangular film members, and has a welded portion in which the two film members are welded to each other. Since the liquid storage container of this aspect includes a pillow-type liquid storage container, the manufacturing cost of the liquid storage container can be reduced.

4. In the liquid storage container of the above aspect, the liquid storage bag may be composed of four rectangular film members, which include two main films that form main faces of the liquid storage bag, the main films facing each other, and two side films that face each other, and have a welded portion in which one of these four film members is welded to the other film members. According to this aspect, a liquid storage container having a pillow-type liquid storage bag is provided.

5. In the above aspect, the liquid storage box may have a cuboid internal space as an accommodating space for accommodating the liquid storage bag, and the liquid storage container may have a first wall, which is one of six walls of the accommodating space, the first wall facing part of the welded portion, and the liquid storage container may be capable of taking a posture in which the first wall is taken as a bottom. The liquid storage container of this aspect can be equipped in the liquid ejection apparatus in the posture, the welded portion can be located on the bottom. Accordingly, when the lower end of the liquid storage container including the welded portion receives a water head pressure, the welded portion is supported by the bottom of the liquid storage box. Thus, a load to the welded portion can be reduced.

6. In the above aspect, the liquid storage box may be made of a cardboard. With the liquid storage container of this aspect, the manufacturing cost of the liquid storage box can be reduced.

The present disclosure can be embodied in various forms other than liquid storage containers. For example, the present disclosure can be embodied as a method for manufacturing a liquid storage container, a liquid ejection system that includes a liquid storage container and a liquid ejection apparatus, and the like.

What is claimed is:

1. A liquid storage container that is equipped in a liquid ejection apparatus and supplies liquid to the liquid ejection apparatus, the liquid storage container comprising:
a liquid storage box forming an outer shell of the liquid storage container; and
a liquid storage bag accommodated in the liquid storage box, the liquid storage bag having a flexibility for storing liquid therein, wherein
regardless of a posture of the liquid storage box, a first inner circumferential length of the liquid storage bag in one cross-section is larger than a second inner circumferential length of the liquid storage box in the one cross-section.

2. The liquid storage container according to claim 1, wherein the first inner circumferential length is longer than the second inner circumferential length by 10 mm or more.

3. The liquid storage container according to claim 1, wherein the liquid storage bag is composed of two rectangular film members, and has a welded portion in which the two film members are welded to each other.

4. The liquid storage container according to claim 1, wherein the liquid storage bag is composed of four rectangular film members, which include two main films that form main faces of the liquid storage bag, the main films facing each other, and two side films that face each other, and has a welded portion in which one of these four film members is welded to the other film members.

5. The liquid storage container according to claim 3, wherein the liquid storage box has a cuboid internal space as an accommodating space for accommodating the liquid storage bag, and the liquid storage container has a first wall, which is one of six walls of the accommodating space, the first wall facing part of the welded portion, and the liquid storage container is configured to take a posture in which the first wall is taken as a bottom.

6. The liquid storage container according to claim 1, wherein the liquid storage box is made of a cardboard.

7. A liquid ejection system that ejects liquid onto a medium, the liquid ejection system comprising:
the liquid storage container according to claim 1; and
a liquid ejection apparatus that ejects liquid supplied from the liquid storage container.
